(19) United States
(12) Patent Application Publication
(10) Pub. No.: US 2023/0311120 A1
(43) Pub. Date: Oct. 5, 2023

(54) MICROFLUIDIC OPTICAL FILM FOR BIO-ASSAY SIGNAL ENHANCEMENT

(71) Applicant: 3M INNOVATIVE PROPERTIES COMPANY, St. Paul, MN (US)

(72) Inventors: Bharat R. Acharya, Woodbury, MN (US); Kurt J. Halverson, Lake Elmo, MN (US); Robert M. Biegler, Woodbury, MN (US); Timothy J. Lindquist, Woodbury, MN (US); John Allen Wheatley, Stillwater, MN (US); James A. Phipps, River Falls, WI (US); Joshua J. Loga, River Falls, WI (US); Brett J. Sitter, Marine on St Croix, MN (US)

(21) Appl. No.: 18/186,371

(22) Filed: Mar. 20, 2023

Related U.S. Application Data
(60) Provisional application No. 63/324,697, filed on Mar. 29, 2022.

(51) Int. Cl. B01L 3/00

(52) U.S. Cl. CPC B01L 3/502715; G02B 5/085

(57) ABSTRACT

An optical system for examining an optical characteristic of a test material at at least a first wavelength includes an elongated hollow structure elongated along a length thereof and having one or more walls extending along the length of the hollow structure and defining an elongated chamber therebetween configured to receive the test material. The elongated hollow structure includes at least a first light opening, such that for the at least the first wavelength, the one or more walls have an optical reflectance of greater than about 50% for incident angles of up to at least 40 degrees, and at least one of the at least the first light opening has an optical transmittance of greater than about 50% for at least one incident angle.

### SUMMARY

In some aspects of the present description, an optical system for examining an optical characteristic of a test material at at least a first wavelength is provided, the optical system including an elongated hollow structure elongated along a length thereof and having one or more walls extending along the length of the hollow structure and defining an elongated chamber therebetween configured to receive the test material. The elongated hollow structure includes at least a first light opening, such that for the at least the first wavelength, the one or more walls have an optical reflectance of greater than about 50% for incident angles of up to at least 40 degrees, and at least one of the at least the first light opening has an optical transmittance of greater than about 50% for at least one incident angle.

In some aspects of the present description, an optical system for examining an optical characteristic of a test material at at least a first wavelength is provided, the optical system having a main channel extending along a first direction and at least one branch channel extending along a different second direction from a first location of the main channel between longitudinal ends of the main channel. Each of the main and branch channels include an open top, a closed bottom, and one or more walls extending from the closed bottom to the open top. At least about 60% of the open top of the main channel, but no more than about 40% of the open top of each of the branch channels, is covered with a reflective top layer. Each of the reflective top layer and the one or more walls have an optical reflectance of greater than about 50% for incident angles of up to at least 50 degrees at the at least the first wavelength.

### BRIEF DESCRIPTION OF THE DRAWINGS

FIG. 1 is a side, cutaway view of an optical system for examining an optical characteristic of a test material, in accordance with an embodiment of the present description;

FIGS. 2A-2D provide plan views of alternate shapes for an elongated chamber in the optical system of FIG. 1, in accordance with an embodiment of the present description;

FIG. 3 illustrates the layered architecture of the multilayer optical films of an optical system for examining an optical characteristic of a test material, in accordance with an embodiment of the present description;

FIG. 4 is a side, cutaway view of an optical system for examining an optical characteristic of a test material, in accordance with an alternate embodiment of the present description;

FIGS. 5A-5B provide side, cutaway views of an optical system for examining an optical characteristic of a test material, in accordance with an alternate embodiment of the present description;

FIGS. 6A-6B provide side, cutaway views of an optical system for examining an optical characteristic of a test material, including receptor sites, in accordance with an alternate embodiment of the present description;

FIGS. 7A-7C provide side, cutaway views of an optical system for examining an optical characteristic of a test material, including a porous material with receptor sites, in accordance with an alternate embodiment of the present description;

FIG. 8 is a side, cutaway view of an optical system for examining an optical characteristic of a test material, in accordance with an alternate embodiment of the present description; and

FIGS. 9A-9B provide a top and side view, respectively, of an optical system for examining an optical characteristic of a test material, featuring side channels, in accordance with an embodiment of the present description.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

Biological assays (bio-assays) utilizing microfluidic channels allow diagnostic tests to be performed with a significantly lower sample volume in a compact form factor. These configurations may also reduce or eliminate the need for sample preparation and washing steps, reducing the overall time required to run assays. Some microfluidic devices incorporate automatic fluidic controls such as flow rate, mixing, etc. using features like valves and switches. However, as the sample volume decreases, the total sample available for light to interact with becomes low, reducing the signal strength. In addition, when the small sample volume is spread across thin microfluidic channels, the thickness of the channels limits the effective pathlength available for light to interact with the sample. This reduces the sensitivity of microfluidic devices in low concentration regimes. Technologies and device architectures that increase the effective pathlength have potential to increase the sensitivity of microfluidic devices.

According to some aspects of the present description, an optical system for examining an optical characteristic of a test material at at least a first wavelength may include an elongated hollow structure. In some embodiments, the elongated hollow structure may be elongated along a length (e.g., along an x-axis) thereof and may include one or more walls extending along the length of the hollow structure and defining an elongated chamber therebetween.

In some embodiments, the one or more walls may include a metal layer extending along the length of the hollow structure. In some embodiments, the metal layer may be exposed to the elongated chamber and configured to come into physical contact, or near physical contact, with the test material. In other embodiments, the metal layer may be embedded in the one or more walls so as not to make physical contact with the test material. For example, in some embodiments, the metal layer may be disposed between two outer layers of a separate material (e.g., a polycarbonate material, or any other appropriate material). In such embodiments, the metal layer may be adhered to the outer layers by an adhesive (e.g., an optically clear adhesive). In some embodiments, the metal layer may include one or more of gold, silver, aluminum, copper, and tin. In some embodiments, at least a portion of the one or more walls may include an optical diffuser exposed to the elongated chamber and configured to scatter light primarily forwardly along the length of the hollow structure.

In some embodiments, the one or more walls may include a multilayer optical film extending along the length of the hollow structure. The multilayer optical film may include a plurality of microlayers numbering at least 4, or at least 5, or at least 8, or at least 10, or at least 20, or at least 50, or at least 100, or at least 150, or at least 200, or at least 250, or at least 300 in total. In some embodiments, each of the microlayers may have an average thickness of less than about 500 nm, or about 450 nm, or about 400 nm, or about 350 nm, or about 300 nm, or about 250 nm, or about 200 nm.

In some embodiments, at least some of the microlayers in the plurality of microlayers may include an inorganic material. In such embodiments, the inorganic material may include one or more of an oxide, a nitride, a carbide, and a metal. In embodiments where the inorganic material includes an oxide, the oxide may be one or more of a metal oxide, silicon oxide, silicon dioxide, zirconium oxide, and titanium oxide. In embodiments where the inorganic material includes a nitride, the nitride may include one or more of silicon nitride, zirconium nitride and titanium nitride. In embodiments where the inorganic material includes a carbide, the carbide may include one or more of silicon carbide and germanium carbide. In embodiments where the inorganic material includes a metal, the metal may include one or more of gold, silver and aluminum. In some embodiments, at least some of the microlayers in the plurality of microlayers may include an organic material. In such embodiments, the organic material may include a polymer.

In some embodiments, the elongated chamber may be configured to receive the test material. In some embodiments, the elongated hollow structure may include at least a first light opening. In some embodiments, the at least the first light opening may be disposed proximate a first end of the one or more walls

In some embodiments, for the at least the first wavelength, the one or more walls may have an optical reflectance of greater than about 50% for incident angles of up to at least 40 degrees. In some embodiments, at least one of the at least the first light opening may have an optical transmittance of greater than about 50%, or greater than about 60%, or greater than about 70%, or greater than about 80%, or greater than about 90%, or greater than about 95% for at least one incident angle.

In some embodiments, the test material may include a liquid test material configured to substantially fill the elongated chamber. In other embodiments, the test material may be a solid test material configured to be disposed along at least 50% of the length of the elongated chamber. In some embodiments, the elongated chamber, as seen from a top view, may be substantially straight along at least 50% of its length. In other embodiments, the elongated chamber, as seen from a top view, may have a serpentine shape along at least 50% of its length.

In some embodiments, the optical system may further include a light source disposed in the elongated hollow structure proximate a second end, opposite the first end, of the one or more walls. In such embodiments, the light source may be configured to emit light having the at least the first wavelength. In some embodiments, the emitted light may be configured to propagate along the elongated hollow structure and exit the elongated hollow structure through the at least the first light opening after going through the test material and being reflected multiple times by the one or more walls. In some embodiments, the optical system may not include any light openings proximate the second end of the one or more walls. In some embodiments, the at least the first light opening include the first light opening disposed proximate a first end of the one or more walls and a different second light opening disposed proximate an opposite second end of the one or more walls. In some embodiments, the at least the first light opening may further include a physical third light opening for delivering the test material to the elongated chamber therethrough.

In some embodiments, for the at least the first wavelength, the first light opening may have an optical transmittance of greater than about 60% for the at least one incident angle and the second light opening may have an optical reflectance of greater than about 60% for at least one incident angle.

In some embodiments, the first light opening may be disposed proximate a first end of the one or more walls, and the hollow structure may further include at least a second opening disposed proximate an opposite second end of the one or more walls. In some embodiments, the second opening may be configured to receive an optical fiber therethrough for injecting light into the elongated chamber. In some embodiments, the first light opening is an optical, but not a physical, light opening. In other embodiments, the first light opening is a physical light opening. In some embodiments, at least one of the at least the first light opening may include a plurality of regularly arranged microstructures for redirecting light.

In some embodiments, the at least one of the one or more walls (e.g., a “bottom” wall) may include a recessed cavity configured to receive and be substantially filled with the test material. In some embodiments, the at least one of the one or more walls may be configured to have the test material coated thereon so that the coated test material faces the elongated chamber.

In some embodiments, at least a portion of the one or more walls may include a porous section facing the elongated chamber. In such embodiments, a second material may substantially fill the pores and is configured to interact with the test material. In some embodiments, the interaction between the test material and the second material may result in a resulting material, wherein same optical characteristics of the test and resulting materials are different from each other by at least 1%, or at least 2%, or at least 5%, or at least 10%, or at least 20%, or at least 30% at the at least the first wavelength. In some such embodiments, the same optical characteristics of the test material and resulting material may be optical absorbances at the at least the first wavelength.

In some embodiments, at least a portion of an innermost surface of the one or more walls facing the elongated chamber may be functionalized with receptors configured to bind with analytes in the test material. In some such embodiments, the receptors may include biological receptors. In such embodiments, the biological receptors may include one or more of enzymes, enzyme inhibitors, antigens, hormones, antibodies, polynucleotide, proteins, steroids, cells, ribozymes and cytokines. In some such embodiments, the analytes may include biological analytes. In such embodiments, the biological analytes may include one or more of enzymes, enzyme inhibitors, antigens, hormones, antibodies, polynucleotide, proteins, steroids, cells, ribozymes and cytokines. In some such embodiments, at least some of the analytes may include, or may be attached to, a fluorescent labeling agent configured to absorb light at the at least the first wavelength and emit light having a different second wavelength. In some embodiments, the receptors may be further configured to bind with second analytes. In such embodiments, at least some of the second analytes may comprise, or may be attached to, a fluorescent labeling agent configured to absorb light at the at least the first wavelength and emit light having a different second wavelength. In some embodiments, the optical system of claim may further include a porous material disposed in the elongated chamber. In such embodiments, the porous material may include pores and receptors bound therein. In such embodiments, the receptors may be configured to bind with analytes in the test material.

In some embodiments, an innermost surface of at least portions of the one or walls facing the elongated chamber may be hydrophilic. In other embodiments, an innermost surface of at least portions of the one or walls facing the elongated chamber may be hydrophobic. As used herein, the term “hydrophilic” refers to a surface that is wet by aqueous solutions and does not express whether or not the material absorbs aqueous solutions. By “wet” it is meant that the surface exhibits spontaneous wicking when contacted with an aqueous fluid. An aqueous fluid comprises 50% or more by volume of water. In some embodiments, a hydrophilic surface exhibits and advancing (maximum) water contact angle of less than 90 degrees, preferably 45 degrees or less. As used herein, the term “hydrophobic” refers to a surface that lacks spontaneous wicking when contact with an aqueous fluid. In some embodiments, a hydrophobic surface exhibits an advancing water contact angle of 70 degrees or greater, preferably 90 degrees or greater.

In some embodiments, the elongated chamber may have a cross-sectional area in a plane orthogonal to the length of the hollow structure, and wherein the cross-sectional area varies by less than about 20%, or less than about 15%, or less than about 10%, or less than about 5% along a majority of the length of the hollow structure. In other embodiments, the elongated chamber may have a cross-sectional area in a plane orthogonal to the length of the hollow structure, and wherein the cross-sectional area varies by greater than about 20%, or greater than about 30%, or greater than about 40%, or greater than about 50% along a majority of the length of the hollow structure. In some embodiments, along a majority of the length of the hollow structure, the elongated chamber may taper from a larger cross-section to a narrower cross-section.

According to some aspects of the present description, an optical system for examining an optical characteristic of a test material at at least a first wavelength may include a main channel extending along a first direction (e.g., along an x-axis of the system) and at least one branch channel extending along a different second direction (e.g., along a y-axis of the system) from a first location of the main channel between longitudinal ends of the main channel. In some embodiments, each of the main and branch channels may have an open top, a closed bottom, and one or more walls extending from the closed bottom to the open top. In some embodiments, at least about 60%, or at least about 65%, or at least about 70%, or at least about 80%, or at least about 85%, or at least about 90% of the open top of the main channel, but no more than about 40%, or about 35%, or about 30%, or about 25%, or about 20%, or about 15%, or about 10%, or about 5% of the open top of each of the branch channels, may be covered with a reflective top layer. In some embodiments, each of the reflective top layer and the one or more walls may have an optical reflectance of greater than about 50% for incident angles of up to at least 50 degrees at the at least the first wavelength.

In some embodiments, the optical system may further include at least one light source disposed proximate one of the longitudinal ends of the main channel. In such embodiments, the at least one light source may be configured to emit light having the at least the first wavelength. In some embodiments, the optical system may further include at least one detector disposed proximate the other one of the longitudinal ends of the main channel. In such embodiments, the at least one detector may be configured to detect the emitted light. In such embodiments, the at least one detector include one or an array including one or more of a charged coupled device (CCD), a charge injection device (CID), a photodiode, an organic photodiode (OPD), a complementary metal-oxide-semiconductor (CMOS), and a thin-film transistor (TFT). In some embodiments, the test material may be configured to change an optical intensity of the emitted light, and at least one of the detectors in the at least one detector may be configured to detect the change in the optical intensity of the emitted light.

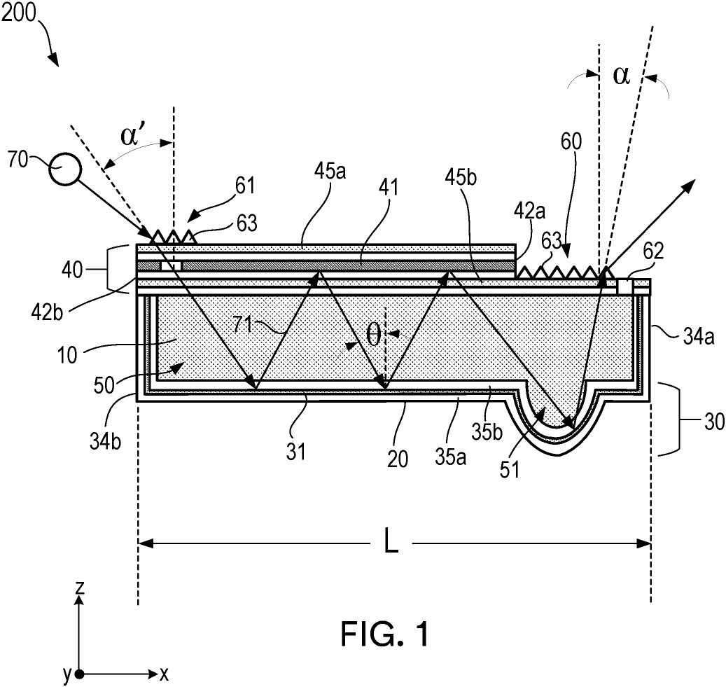

Turning now to the figures, FIG. 1 is a side, cutaway view of an optical system for examining an optical characteristic of a test material, according to an embodiment of the present description. In some embodiments, optical system 200 includes an elongated hollow structure 20 which may be configured to examine an optical characteristic (e.g., an amount of optical absorbance) of a test material 10. In some embodiments, the elongated hollow structure 20 may include one or more walls (including, for example, wall 40 and wall 30 as shown in FIG. 1) extending along the length L (e.g., along the x-axis as shown in FIG. 1) of elongated hollow structure 20 and defining an elongated chamber 50. In some embodiments, test material 10 may be placed within elongated chamber 50.

In some embodiments, the elongated hollow structure 20 may further include at least a first light opening. In some embodiments, the at least the first light opening may include a first light opening 60 disposed proximate a first end 34a, 42a of the one or more walls 30, 40 and a different second light opening 61 disposed proximate an opposite second end 34b, 42b of the one or more walls 30, 40. In some embodiments, the at least the first light opening may further include a physical third light opening 62 for delivering test material 10 to elongated chamber 50 therethrough. In some embodiments, one or more of the first light opening 60 and second light opening 61 may be an optical light opening, but not a physical light opening (i.e., may be layer which allows light to be transmitted therethrough.) In other openings, one or more of the first light opening 60 and second light opening 61 may be a physical light opening.

It should be noted that the positioning of any of the at least the first light openings (including first light opening 60, second light opening 61, and third light opening 62) may be disposed on any appropriate surface of optical system 200. In some embodiments, for example, when either the first light opening 60 or second light opening 61 are optical light openings but not physical light openings, the optical light opening may be on any surface of optical system 200. The location and number of openings depicted in the figures and described herein are examples only, and not intended to be limiting in any way. In some embodiments, at least some of the at least the first light opening may be wavelength selective (e.g., have a layer such as a multilayer optical film over the opening which substantially transmits some wavelengths of light and substantially reflects other wavelengths of light.)

In some embodiments, an innermost surface of at least portions of the one or more walls 30, 40 facing elongated chamber 50 may be hydrophilic. In other embodiments, an innermost surface of at least portions of the one or more walls 30, 40 facing elongated chamber 50 may be hydrophobic.

In some embodiments, for the at least the first wavelength, the one or more walls 30, 40 may have an optical reflectance of greater than about 50%, or about 60%, or about 70%, or about 80%, or about 90%, or about 95% for incident angles θ of up to at least 40, degrees, or at least 45 degrees, or at least 50 degrees, or at least 55 degrees, or at least 60 degrees, or at least 65 degrees, or at least 70 degrees. In some embodiments, for the at least the first wavelength, the one or more walls 30, 40 may not exhibit a decrease in reflectance as a function of angle.

In some embodiments, at least one of the one or more light opening may have an optical transmittance of greater than about 50%, or greater than about 60%, or greater than about 70%, or greater than about 80%, or greater than about 90%, or greater than about 95%, for at least one incident angle α, α′.

In some embodiments, the optical system 200 may further include a light source 70 configured to emit light 71 having the at least the first wavelength. In such embodiments, light source 70 may be proximate one of light openings 60, 61 (e.g., light opening 61, as shown in FIG. 1) such that light 71 enters through light opening 61 and propagates along elongated hollow structure 20 and exits the elongated structure through light opening 60 after first going through test material 10 and being reflected multiple times by walls 30, 40. Stated another way, light source 70 may be proximate a second end 34b, 42b of walls 30, 40, opposite a first end 34a, 42a of walls 30, 40, and emitted light 71 may enter the elongated hollow structure 20 through second light opening 61 near second end 34b, 42b and propagate through chamber 50 and test material 10, finally exiting elongated hollow structure through first light opening 60 near first end 34a, 42a. In some embodiments, at least one of light openings 60, 61 may include a plurality of regularly arranged microstructures 63 (e.g., linear prisms) for redirecting light (e.g., redirecting light exiting optical system 200 toward a detector/sensor, or redirecting light entering the optical system 200 into text material 10).

In some embodiments, the one or more walls 30, 40 may include a metal layer 31, 41, extending substantially along the length L of elongated hollow structure 20. In some embodiments, at least one of metal layer 31, 41 may be configured to come into physical contact, or near physical contact, with test material 10. In other embodiments, at least one of metal layer 31, 41 may be embedded in the one or more walls 30, 40 so as not to make contact with test material 10. For example, as shown in FIG. 1, metal layer 31 may be embedded between outer layers 35a and 35b, and metal layer 41 may be embedded between outer layers 45a and 45b. Outer layers 35a, 35b, 45a, and 45b may be any appropriate material, such as polycarbonate, and such material may be configured to be formed through a process such as thermoforming. In some embodiments, walls 30 and 40 may include additional layers (not labeled) such as an optically clear adhesive binding outer layers 35a, 35b, 45a, 45b to metal layers 31, 41. In some embodiments, metal layers 31, 41 may include one or more of gold, silver, aluminum, copper, and tin. In some embodiments, at least one of the one or more walls (e.g., wall 30) may include a recessed cavity 51 configured to receive and be substantially filled with the test material.

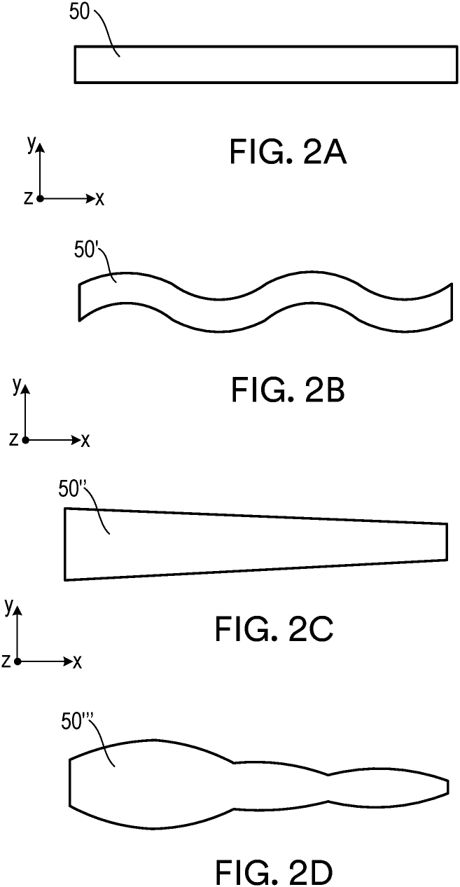

FIGS. 2A-2D provide plan views of various shapes for elongated chamber 50 in the optical system 200 of FIG. 1, as seen in a top, plan view. The shapes shown in FIGS. 2A-2D are exemplary only and are not intended to be limiting in any sense. In some embodiments, as shown in FIG. 2A, elongated chamber 50 may be substantially straight (e.g., along the x-axis of FIG. 2A) along at least 50% of its length. Stated another way, elongated chamber 50 may have a cross-sectional area in a plane orthogonal to the length of the hollow structure (such as length L as shown in FIG. 1), and wherein the cross-sectional area varies by less than about 20%, or less than about 15%, or less than about 10%, or less than about 5% along a majority of the length of the hollow structure.

In other embodiments, such as the embodiment of FIG. 2B, elongated chamber 50″ may have a serpentine shape along at least 50% of its length. In some embodiments, such as shown in FIG. 2C, the elongated chamber 50′ may taper along a majority of the length of the hollow structure, from a larger cross-section to a narrower cross-section. In some embodiments, such as shown in FIG. 2D, elongated chamber 50‴ may have a cross-sectional area in a plane orthogonal to the length of the hollow structure, such that the cross-sectional area varies by greater than about 20%, or greater than about 30%, or greater than about 40%, or greater than about 50% along a majority of the length of the hollow structure. As described elsewhere herein, the embodiments shown in FIGS. 2A-2D are only examples and not intended to be limiting.

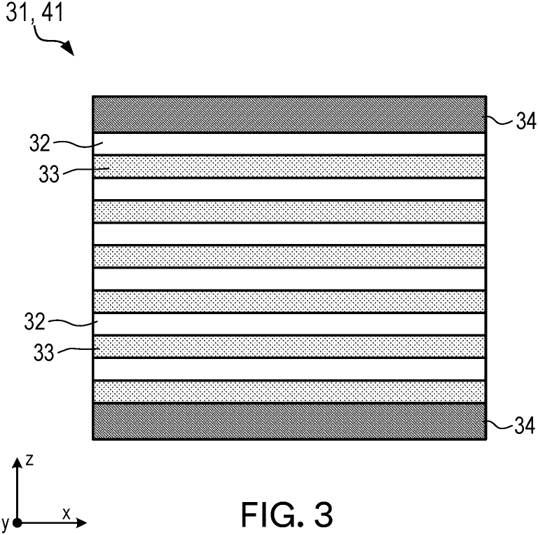

FIG. 3 illustrates the layered architecture of the multilayer optical films of an optical system for examining an optical characteristic of a test material, such as the metal layers 31, 41 of the embodiment shown in FIG. 1. In some embodiments, the one or more walls 30, 40 may include a multilayer optical film 31, 41 (e.g., a metal layer including multiple layers) extending along the length of the hollow structure. In some embodiments, the multilayer optical films 31, 41 may include a plurality of alternating microlayers 32, 33 numbering at least 4, or at least 5, at least 8, or at least 10, or at least 20, or at least 50, or at least 100, or at least 150, or at least 200, or at least 250, or at least 300 in total. In some embodiments, each of the microlayers 33, 34 may have an average thickness of less than about 500, or less than about 450, or less than about 400, or less than about 350, or less than about 300, or less than about 250, or less than about 200 nm. In some embodiments, the indices of refraction of microlayers 32 and 33 may be configured to determine optical characteristics of multilayer optical films 31, 41 (e.g., microlayers 32 may have a different index of refraction than microlayers 33). In some embodiments, a thickness gradient across microlayers 32, 33 may be configured to determine optical characteristics of multilayer optical films 31, 41. In some embodiments, multilayer optical films 31, 41 may further include one or more outer skin layers 34.

In some embodiments, at least some of microlayers 32, 33 in the plurality of microlayers may include an inorganic material. In some such embodiments, the inorganic material may include one or more of an oxide, a nitride, a carbide, and a metal. In some embodiments including an oxide, the oxide may include one or more of a metal oxide, silicon oxide, silicon dioxide, zirconium oxide, and titanium oxide. In some embodiments including a nitride, the the nitride may include one or more of silicon nitride, zirconium nitride, and titanium nitride. In some embodiments including a carbide, the carbide may include one or more of silicon carbide and germanium carbide. In some embodiments including a metal, the metal may include one or more of gold, silver, and aluminum. In some embodiments, at least some of the microlayers in the plurality of microlayers may include an organic material. In some such embodiments, the organic material may include a polymer.

In some cases, the plurality of first layers 32, 33 may include a plurality of alternating first polymeric A layers 32 and first polymeric B layers 33. The first polymeric A layers 32 may be substantially isotropic, i.e., refractive indices along two orthogonal in-plane directions are similar (nx ≈ ny) and the first polymeric B layers 33 may be substantially birefringent (i.e., nx ≠ ny. for example, the first polymeric A and first polymeric B layers 32, 33 may be designed using alternating layers of birefringent PEN and isotropic PMMA. Other combinations of high and low index materials may be used, such as alternating PET and PMMA layers.

In some other cases, the plurality of first layers 32, 33 may include a plurality of vapor deposited alternating first organic 32 and first inorganic 33 layers. For instance, the first organic layers 32 may include a polymer. For example, the polymeric first layers 32 may include one or more of a polycarbonate (PC), a polymethyl methacrylate (PMMA), a polyethylene terephthalate (PET), CoPMMA with PET, a glycol-modified polyethylene terephthalate (PETG), a polyethylene naphthalate (PEN), PC:PETG alloy, and a PEN/ PET copolymer.

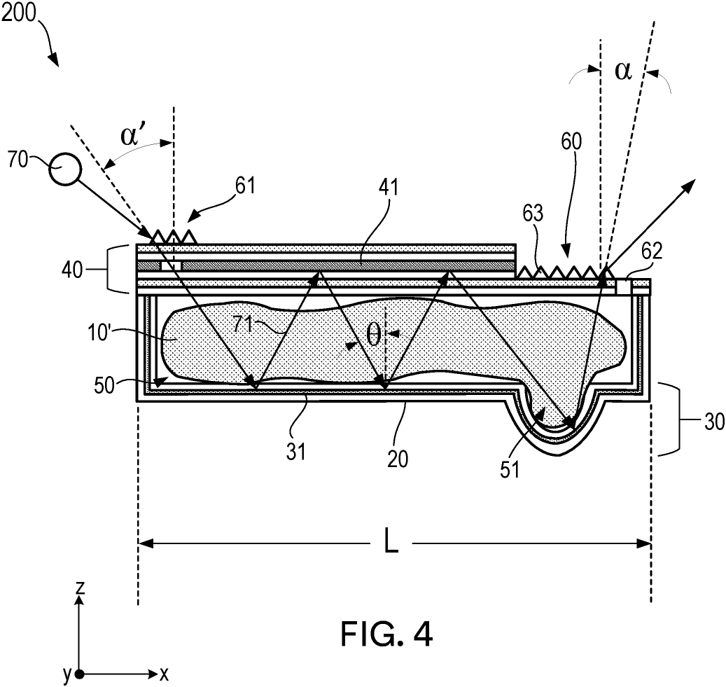

FIGS. 4-8 illustrate alternate embodiments of optical system 200 of FIG. 1, and, as such, may share like-numbered components with optical system 200 of FIG. 1. Unless specifically stated otherwise, like-numbered components in each of FIGS. 4-8 shall be assumed to have similar functions and/or purposes as the corresponding components of FIG. 1. Therefore, the like numbered components of FIGS. 4-8 may not be described further in the following discussion and should be assumed to serve the same function/purpose of the components as described elsewhere herein.

FIG. 4 is a side, cutaway view of an alternate embodiment of optical system 200 for examining an optical characteristic of a test material 10′. In the embodiment of FIG. 1, test material 10 is shown to be a test material configured to substantially fill elongated chamber 50 (e.g., a liquid test material). In the embodiment of FIG. 4, test material 10′ is a solid test material configured to be disposed along at least 50% of the length L of elongated chamber 50. Light 71 emitted by light source 70 enters elongated chamber 50 via second light opening 61, is reflected by walls 30, 40 through solid test material 10′, and at least a portion of light 71 exits elongated chamber 50 via first light opening 60, where it may be observed and/or detected.

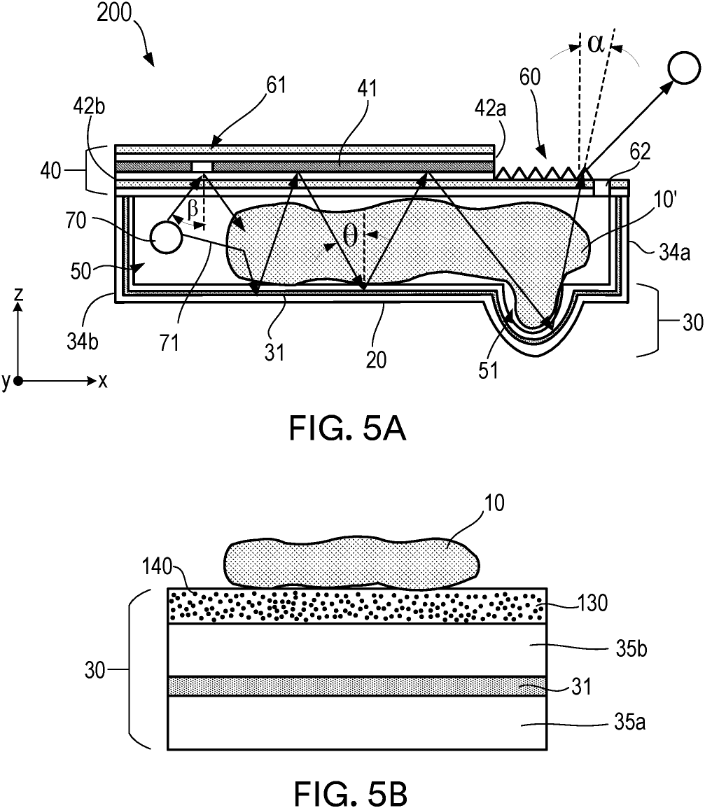

FIGS. 5A-5B provide side, cutaway views of an alternate embodiment of optical system 200 for examining an optical characteristic of a test material. In the embodiment of FIG. 5A, optical system 200 includes light source 70 disposed in elongated hollow structure 20 (e.g., disposed inside elongated chamber 50) and proximate second end 34b, 42b of walls 30, 40. In some embodiments, light source 70 is configured to emit light 71 having the at least the first wavelength. Emitted light 71 is configured to propagate along elongated hollow structure 20 and exit elongated hollow structure 20 through first light opening 60 near first end 34a, 42a after going through test material 10′ and being reflected multiple times by the one or more walls 30, 40.

In some embodiments, for the at least the first wavelength, the first light opening 60 may have an optical transmittance of greater than about 60% for the at least one incident angle α and the second light opening 61 may have an optical reflectance of greater than about 60% for at least one incident angle β. In some such embodiments, optical system 200 may not include a light opening (e.g., second light opening 61) proximate the second end 34b, 42b of the one or more walls 30, 40 (e.g., such that emitted light 71 is substantially reflected from layer 41 and not transmitted).

FIG. 5B provides a close-up, cross-sectional view of the one or more walls 30, 40 of FIG. 5A (or of any of the embodiments of optical system 200 described herein). In some embodiments of optical system 200, at least a portion of the one or more walls (such as wall 30 shown in FIG. 5B) may include an optical diffuser 130 exposed to elongated chamber 50 (i.e., on outer layer 35b such that it is facing the inside of elongated chamber 50, or directly on the multilayer optical film 31 in embodiments where outer layer 35b is not present). In some embodiments, optical diffuser 30 may be configured to scatter light primarily forwardly along the length of elongated hollow structure 20. In some embodiments, optical diffuser 130 may contain particles 140 which are configured to interact with (e.g., scatter) light passing through optical diffuser 130.

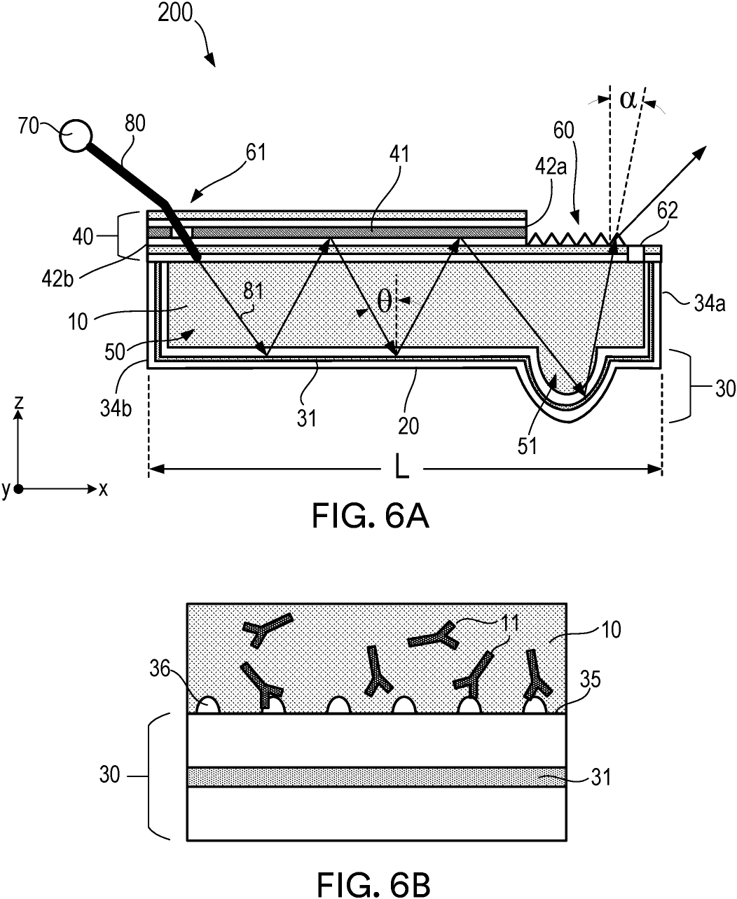

FIG. 6A provides a side, cutaway view of an alternate embodiment of optical system 200. In the embodiment of FIG. 6A, first light opening 60 is disposed proximate a first end 34a, 42a of the one or more walls 30, 40, and hollow structure 20 further includes at least a second opening 61 disposed proximate an opposite second end 34b, 42b of the one or more walls 30, 40. In some embodiments, second opening 61 may be configured to receive an optical fiber 80 therethrough for injecting light 81 into the elongated chamber 50. Light 81 emitted by optical fiber 80 into elongated chamber 50 is reflected by walls 30, 40 through test material 10, and at least a portion of light 81 exits elongated chamber 50 via first light opening 60, where it may be observed and/or detected.

FIG. 6B provides a close-up, cross-sectional view of the one or more walls 30, 40 of FIG. 6A (or of any of the embodiments of optical system 200 described herein). In some embodiments of optical system 200, at least a portion of an innermost surface 35 of wall 30 (and/or wall 40) facing an interior of elongated chamber 50 may be functionalized with receptors 36 configured to bind with analytes 11 in test material 10. In some such embodiments, the receptors may include biological receptors. In such embodiments, the biological receptors may include one or more of enzymes, enzyme inhibitors, antigens, hormones, antibodies, polynucleotide, proteins, steroids, cells, ribozymes, and cytokines. In other such embodiments, the analytes may include biological analytes. In such embodiments, the biological analytes may include one or more of enzymes, enzyme inhibitors, antigens, hormones, antibodies, polynucleotide, proteins, steroids, cells, ribozymes, and cytokines.

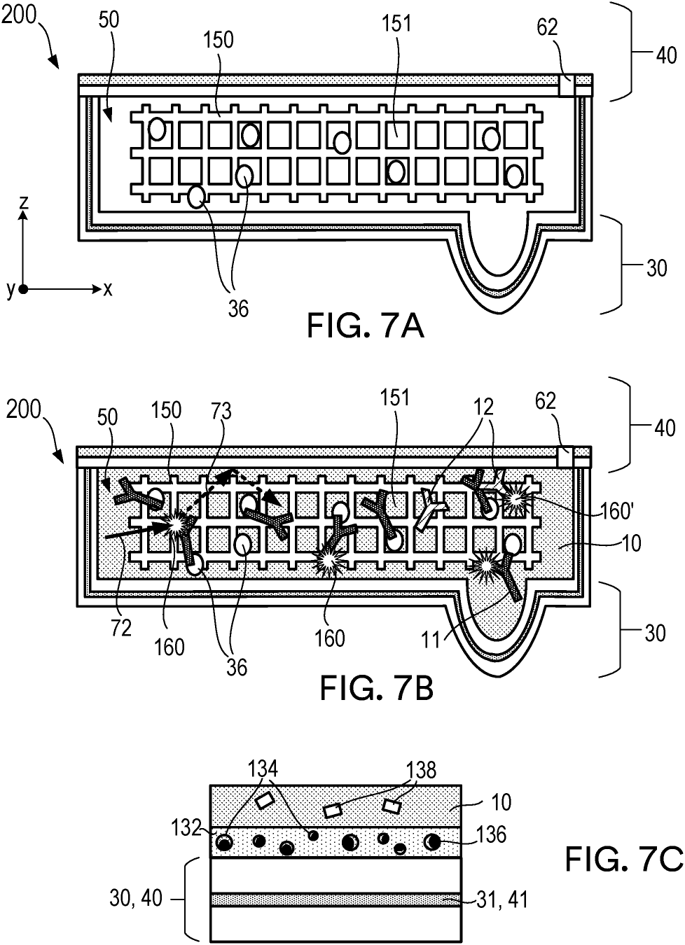

FIGS. 7A-7C provide details on another alternate embodiment of optical system 200. In this embodiment shown in FIGS. 7A and 7B, optical system 200 may further include a porous material 150 disposed in elongated chamber 50. In some embodiments, porous material 150 may include pores 151 and receptors 36 bound therein, wherein the receptors 36 are configured to bind with analytes 11 (FIG. 7B). In some embodiments, at least some of analytes 11 include, or are attached to, a fluorescent labeling agent 160 configured to absorb light 72 at the at least the first wavelength and emit light 73 having a different second wavelength. In some embodiments, receptors 36 may further be configured to bind with second analytes 12, different from first analytes 11. In some embodiments, at least some of second analytes 12 include, or are attached to, fluorescent labeling agent 160′ configured to absorb light 72 at the at least the first wavelength and emit light 73 having a different second wavelength. In some embodiments, at least some of first analytes 11 and second analytes 12 may need to interact for fluorescent labeling agent 160′ to emit light 73.

In some embodiments, as shown in FIG. 7C, the porous material may be embodied as a porous section 132 of the one or more walls 30, 40, where the porous section 132 includes a plurality of pores 134 and faces the interior of elongated chamber 50. In some embodiments, a second material 136 may substantially fill pores 134, and second material 136 may be configured to interact with test material 10. In some embodiments, the interaction between test material 10 and second material 136 may result in a resulting material 138. In some embodiments, same optical characteristics of the test material 10 and resulting material 138 (e.g., measured optical absorbances of both materials) may be different from each other by at least 1%, or at least 2%, or at least 5%, or at least 10%, or at least 20%, or at least 30% at the at least the first wavelength.

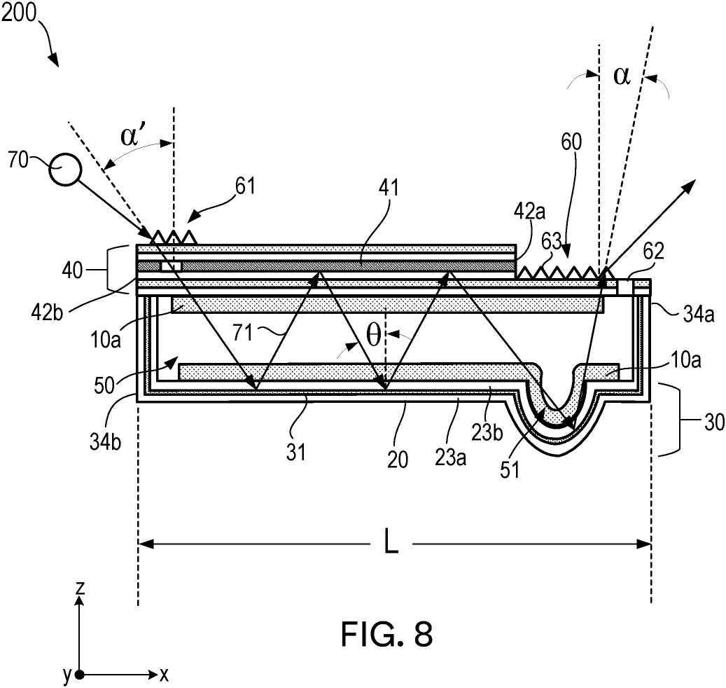

FIG. 8 is a side, cutaway view of another alternate embodiments of optical system 200 for examining an optical characteristic of a test material. The embodiment of FIG. 8 is similar to the embodiment of optical system 200 shown in FIG. 1, with the exception that at least one of the one or more walls 30, 40 may configured to have the test material 10a coated thereon so that the coated test material 10a faces elongated chamber 50.

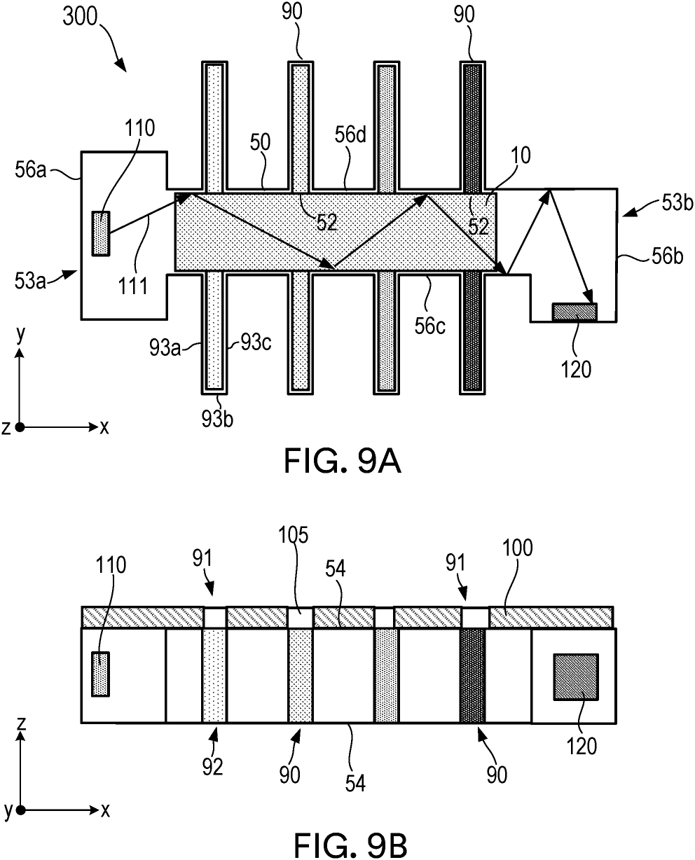

FIGS. 9A-9B provide a top and side view, respectively, of an alternate embodiment of an optical system 300 for examining an optical characteristic of a test material. FIGS. 9A and 9B should be examined together for the following discussion. In some embodiments, optical system 300 may include a main channel 50 extending along a first direction (e.g., the x-axis as shown in FIG. 9A) and at least one branch channel 90 extending along a different second direction (e.g., the y-axis) from a first location 52 of main channel 50 between longitudinal ends 53a, 53b of the main channel 50. In some embodiments, each of the main channel 50 and branch channels 90 may include an open top 54, 91, a closed bottom 55, 92 and one or more walls 56a-56d, 93a-93c extending from the closed bottom 55 to the open top 54. In some embodiments, at least about 60%, or at least about 65%, or at least about 70%, or at least about 80%, or at least about 85%, or at least about 90% of the open top 54 of main channel 50, but no more than about 40%, or about 35%, or about 30%, or about 25%, or about 20%, or about 15%, or about 10%, or about 5% of open top 91 of each of branch channels 90, may be covered with a reflective top layer 100. In some embodiments, each of the reflective top layer 100 and the one or more walls 56a-56d, 93a-93c may have an optical reflectance of greater than about 50% for incident angles (such as angle θ, FIG. 1) of up to at least 50 degrees at the at least the first wavelength.

In some embodiments, optical system 300 may further include at least one light source 110 disposed proximate one end 53a of the longitudinal ends 53a, 53b of main channel 50. In some embodiments, light source 110 may be configured to emit light 111 having the at least the first wavelength. In some embodiments, optical system 300 may further include at least one detector 120 disposed proximate the other one end 53b of the longitudinal ends 53a, 53b of main channel 50. In some embodiments, detector 120 may be configured to detect emitted light 111. In some embodiments, the at least one detector 111 may include one or an array of a charged coupled device (CCD), a charge injection device (CID), a photodiode, an organic photodiode (OPD), a complementary metal-oxide-semiconductor (CMOS), and a thin-film transistor (TFT). In some embodiments, test material 10 may be configured to change an optical intensity of the emitted light 111, and wherein at least one of the detectors 120 may be configured to detect the change in the optical intensity of emitted light 111. The locations of both light source 110 and detector 120 as shown in the figures and described herein is not intended to be limiting. Additional locations and relative configurations for the light source 110 and detector 120 may be possible within the scope and intent of this description. In some embodiments, light source 110 and detector 120 may be disposed on the top or bottom of the plane of the main channel 50, or in any other appropriate location.

In some embodiments, an optical characteristic of test material 10 may be measured and/or observed at different branch channels 90 along the length of main channel 50 to determine a condition of the test material 10 at each branch channel 90. For example, a color of each branch channel 90 along the length of main channel 50 may be observed and compared to the colors of other branch channels 90 to determine an amount of optical absorbance seen at each branch channel 90. For example, as shown in FIGS. 9A-9B, the color of the branch channels 90 becomes darker from left to right as more of light 111 is absorbed by test material 10 along the length of main channel 50. In some embodiments, at least the open top 91 of each of the branch channels 90 may be substantially covered by an optically transparent layer 105 (i.e., a layer that allows viewing of an optical condition of the test material 10 within each branch channel 90.)

It should be noted that, in some embodiments, optical system 300 may not include a detector 120. In such embodiments, the optical characteristics of test material 10 may be observed by examining the conditions visually (e.g., by the human eye, or an external detection system) at each of the branch channels 90 along the length of main channel 50.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description, “substantially equal” will mean about equal where about is as described above. If the use of “substantially parallel” is not otherwise clear to one of ordinary skill in the art in the context in which it is used and described in the present description, “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed:

1. An optical system for examining an optical characteristic of a test material at at least a first wavelength, the optical system comprising an elongated hollow structure elongated along a length thereof and comprising one or more walls extending along the length of the hollow structure and defining an elongated chamber therebetween configured to receive the test material, the elongated hollow structure comprising at least a first light opening, such that for the at least the first wavelength, the one or more walls have an optical reflectance of greater than about 50% for incident angles of up to at least 40 degrees, and at least one of the at least the first light opening has an optical transmittance of greater than about 50% for at least one incident angle.

2. The optical system of claim 1, wherein the one or more walls comprise a metal layer extending along the length of the hollow structure.

3. The optical system of claim 2, wherein the metal layer is exposed to the elongated chamber and configured to come into physical, or near physical, contact with the test material.

4. The optical system of claim 2, wherein the metal layer is embedded in the one or more walls so as to not make physical contact with the test material.

5. The optical system of claim 2, wherein the metal layer comprises one or more of gold, silver, aluminum, copper and tin.

6. The optical system of claim 1, wherein at least a portion of the one or more walls comprises an optical diffuser exposed to the elongated chamber and configured to scatter light primarily forwardly along the length of the hollow structure.

7. The optical system of claim 1, wherein the one or more walls comprise a multilayer optical film extending along the length of the hollow structure and comprising a plurality of microlayers numbering at least 4 in total, each of the microlayers having an average thickness of less than about 500 nm.

8. The optical system of claim 7, wherein at least some of the microlayers in the plurality of microlayers comprise an inorganic material.

9. The optical system of claim 8, wherein the inorganic material comprises one or more of an oxide, a nitride, a carbide, and a metal.

10. The optical system of claim 9, wherein the oxide comprises one or more of a metal oxide, silicon oxide, silicon dioxide, zirconium oxide and titanium oxide.

11. The optical system of claim 9, wherein the nitride comprises one or more of silicon nitride, zirconium nitride and titanium nitride.

12. The optical system of claim 9, wherein the carbide comprises one or more of silicon carbide and germanium carbide.

13. The optical system of claim 9, wherein the metal comprises one or more of gold, silver and aluminum.

14. The optical system of claim 7, wherein at least some of the microlayers in the plurality of microlayers comprise an organic material.

15. The optical system of claim 14, wherein the organic material comprises a polymer.

16. The optical system of claim 1, wherein the test material comprises a liquid test material configured to substantially fill the elongated chamber.

17. The optical system of claim 1, wherein the test material is a solid test material configured to be disposed along at least 50% of the length of the elongated chamber.

18. The optical system of claim 1, wherein the at least the first light opening is disposed proximate a first end of the one or more walls.

19. The optical system of claim 18 further comprising a light source disposed in the elongated hollow structure proximate a second, opposite the first, end of the one or more walls, the light source configured to emit light having the at least the first wavelength, the emitted light configured to propagate along the elongated hollow structure and exit the elongated hollow structure through the at least the first light opening after going through the test material and being reflected multiple times by the one or more walls.

20. The optical system of claim 19 not comprising any light openings proximate the second end of the one or more walls.
